(19) United States
(12) Patent Application Publication
(10) Pub. No.: US 2015/0330797 A1
(43) Pub. Date: Nov. 19, 2015

(54) SYSTEM AND METHOD FOR PROVIDING GATE PATH INFORMATION TO PASSENGERS ON BOARD AN AIRCRAFT UPON AN AIRCRAFT TAXI GATE SELECTION

(71) Applicant: AIRBUS INDIA OPERATIONS PVT. LTD., Bangalore (IN)

(72) Inventor: VIJAY SHUKLA, BANGALORE (IN)

(21) Appl. No.: 14/398,742

(22) PCT Filed: May 3, 2013
(86) PCT No.: PCT/IN13/00298

§ 371 Date: Nov. 4, 2014

(30) Foreign Application Priority Data
May 4, 2012 (IN) 1741/CHE/2012

(51) Int. Cl. G01C 21/20; B64D 11/00; B64F 1/30

(52) U.S. Cl. CPC G01C 21/206; B64F 1/30; B64D 11/0015

(57) ABSTRACT

A system and method for providing gate path information to passengers on board an aircraft upon an aircraft taxi gate selection are disclosed. In one embodiment, a communication link is established between an aircraft computing system and a ground station system via a communication network provided by the ground station system. Further, a pilot is allowed to select an aircraft taxi gate for taxiing the aircraft upon establishing the communication link. Furthermore, the passengers on board the aircraft are notified of availability of the gate path information and requested to input associated connecting flight information upon the aircraft taxi gate selection. In addition, one or more of the passengers are allowed to input associated connecting flight information upon notification. Also, the gate path information is provided to the one or more passengers based on the input.

### FIELD OF TECHNOLOGY

Embodiments of the present subject matter relate to providing gate path information to passengers on board an aircraft. More particularly, embodiments of the present subject matter relate to providing the gate path information to the passengers on board the aircraft upon an aircraft taxi gate selection.

### BACKGROUND

Generally, passengers need to take boarding passes for connecting flights from an initial departure airport. The boarding pass for the connecting flight may include a terminal number, a connecting flight number, a connecting flight operator code, connecting flight departure gate information, a boarding time, a departure time, baggage information and the like. The passengers may use the connecting flight departure gate information to identify departure gates of the connecting flights in a transit airport. However, airport authorities at the transit airport may change the departure gates of the connecting flights in order to accommodate for higher priority aircrafts or similar situations. In such situations, the passengers on board the aircraft can only get the updated connecting flight departure gate information after arriving at the transit airport via a flight information display device at the transit airport or through audio announcements. In some cases, if the list of flight departures from the transit airport is long then the passengers may have to wait until the connecting flight information (e.g., connecting flight numbers and connecting flight departure gate information) is announced and/or displayed on the flight information display device. However, if departure gate signs are either inappropriately displayed or not available at the transit airport, the passengers may have to walk to the departure gates by asking passerby or by assuming a direction to go to the departure gate. However, the above approaches to go to the departure gate could be misleading especially if the transit airport is very big with complex connecting pathways and transit ways. This may result in passengers traveling a long distance and arriving at the same starting point after traversing several gates or can arrive very late to the departure gates and miss the connecting flights.

### SUMMARY

A system and method for providing gate path information to passengers on board an aircraft upon an aircraft taxi gate selection are disclosed. According to one aspect of the present subject matter, a communication link is established between an aircraft computing system and a ground station system via a communication network provided by the ground station system. Further, a pilot is allowed to select an aircraft taxi gate for taxiing the aircraft upon establishing the communication link. Furthermore, the passengers on board the aircraft are notified of availability of the gate path information and requested to input associated connecting flight information upon the aircraft taxi gate selection. In addition, one or more of the passengers are allowed to input the associated connecting flight information upon notification. Also, the gate path information is provided to the one or more passengers based on the input.

According to another aspect of the present subject matter, the system includes the ground station system, the aircraft computing system residing in the aircraft and a plurality of passenger entertainment display devices, residing in the aircraft, coupled to the aircraft computing system. Further, the aircraft computing system includes a processor, memory coupled to the processor and a display device coupled to the memory. Furthermore, the memory includes a gate path information module and an aircraft taxi gate selection module coupled to the gate path information module. In addition, the system includes the communication network for establishing the communication link between the aircraft computing system and the ground station system. The communication network is provided by the ground station system. Moreover, the aircraft taxi gate selection module allows the pilot to select the aircraft taxi gate for taxiing the aircraft upon establishing the communication link.

Also, the gate path information module has instructions capable of notifying the passengers of availability of the gate path information and requesting to input the associated connecting flight information on the associated one of the plurality of passenger entertainment display devices. Further, the gate path information module has instructions capable of allowing the one or more passengers to input the associated connecting flight information on the associated one of the plurality of passenger entertainment display devices upon notification. Furthermore, the gate path information module has instructions capable of providing the gate path information to the one or more passengers on the associated one of the plurality of passenger entertainment display devices based on the input.

According to yet another aspect of the present subject matter, a non-transitory computer-readable storage medium for providing gate path information to passengers on board the aircraft upon the aircraft taxi gate selection, having instructions that, when executed by a computing device causes the computing device to perform the method described above.

The system and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a flow chart of a method for providing gate path information to passengers on board an aircraft upon an aircraft taxi gate selection, according to one embodiment;

FIG. 2 illustrates exemplary points of interest within a transit airport terminal area;

FIG. 3 illustrates a distance network between some of the points of interest, such as those shown in FIG. 2, according to one embodiment;

FIG. 4 is an exemplary distance matrix formed by using the some of the points of interest, such as those shown in FIG. 3;

FIG. 5 illustrates a system for providing the gate path information to the passengers on board the aircraft upon the aircraft taxi gate selection, according to one embodiment;

FIG. 6 is a block diagram illustrating major components of the system shown in FIG. 5, according to one embodiment;

FIG. 7 is a block diagram illustrating major components of an aircraft computing system, such as the one shown in FIG. 6, according to one embodiment;

FIG. 8 illustrates selectable icons displayed on a passenger entertainment display device, such as the one shown in FIG. 5, according to one embodiment;

FIG. 9 illustrates various options available to the passenger on the passenger entertainment display device upon selecting a transit airport connecting flight information icon, such as the one shown in FIG. 8, according to one embodiment; and

FIG. 10 is a schematic illustrating communication between passenger entertainment display devices, such as those shown in FIG. 5, and a printer and control unit, according to one embodiment.

The drawings described herein are for illustration purposes only and are not intended to limit the scope of the present disclosure in any way.

### DETAILED DESCRIPTION

A system and method for providing gate path information to passengers on board an aircraft upon an aircraft taxi gate selection are disclosed. In the following detailed description of the embodiments of the present subject matter, references are made to the accompanying drawings that form a part thereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

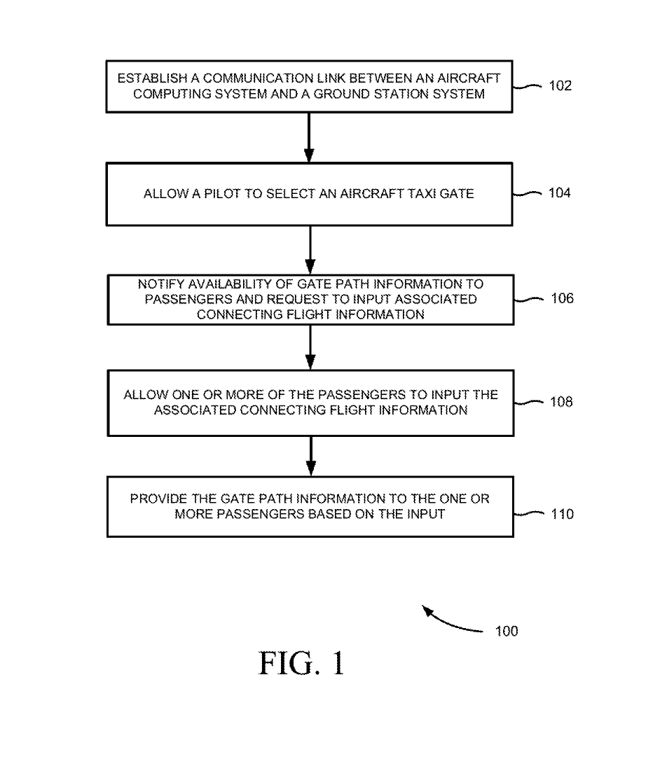

FIG. 1 illustrates a flow chart 100 of a method for providing gate path information to passengers on board an aircraft upon an aircraft taxi gate selection, according to one embodiment. At block 102, a communication link is established between an aircraft computing system, such as a flight management system (FMS), an aircraft cockpit system, an aircraft navigation system and the like and a ground station system (e.g., an airport server) via a communication network (e.g., worldwide interoperability for microwave access (WiMax)) provided by the ground station system. In one embodiment, the communication link between the aircraft computing system and the ground station system is established via the communication network by the aircraft within a range of the communication network at a transit airport.

At block 104, a pilot is allowed to select an aircraft taxi gate for taxiing the aircraft upon establishing the communication link. In one embodiment, aircraft taxi gate selection information including an array of selectable and non-selectable gates at the transit airport and passenger connecting flight information, such as a connecting flight departure gate, an estimated connecting flight departure time, time of boarding, current status, time of arrival and the like associated with connecting flights of the one or more passengers on board the aircraft are obtained and displayed upon establishing the communication link. For example, the aircraft taxi gate selection information and the passenger connecting flight information are obtained from ground station data in the ground station system using an aircraft taxi gate selection and guidance application residing in the aircraft computing system. The aircraft taxi gate selection information and passenger connecting flight information are displayed on a display device in the aircraft computing system. Further, the pilot is allowed to select the aircraft taxi gate based on the displayed aircraft taxi gate selection information and passenger connecting flight information. In another embodiment, an optimized aircraft taxi gate option is automatically provided to the pilot on the display device by the ground station system upon establishing the communication link. The pilot is then allowed to select the provided optimized aircraft taxi gate option for taxiing the aircraft.

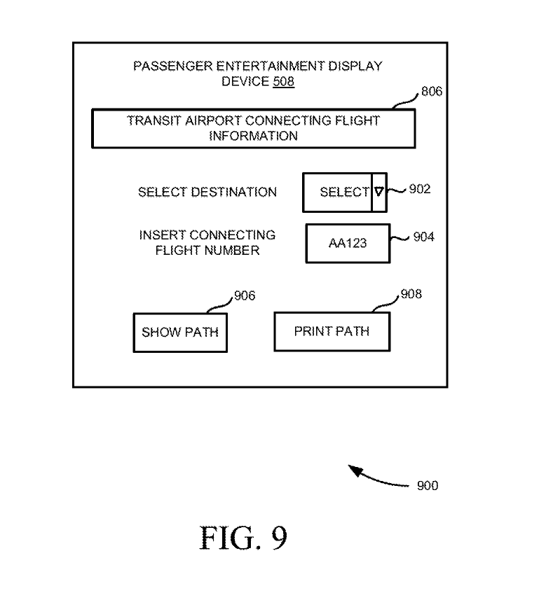

At block 106, the passengers are notified of availability of the gate path information and requested to input associated connecting flight information, such as a connecting flight number, destination information and the like upon the aircraft taxi gate selection via an aircraft paging system and/or passenger entertainment display devices. At block 108, one or more of the passengers are allowed to input the associated connecting flight information upon notification. In one embodiment, the one or more passengers are allowed to input the associated connecting flight information on associated passenger entertainment display devices. This is explained in more detail with reference to FIG. 9.

At block 110, the gate path information is provided to the one or more passengers based on their input. In one embodiment, the gate path information is provided to the one or more passengers on the associated passenger entertainment display devices based on their input. In another embodiment, the gate path information is provided to the one or more passengers on a printed paper by a flight crew upon their input on the associated passenger entertainment display devices. In these embodiments, the gate path information includes an optimized path which an associated passenger can take from the aircraft taxi gate to a connecting flight departure gate in the transit airport. In some embodiments, the connecting flight departure gate is an updated connecting flight departure gate. For example, the optimized path can be a shortest path between the aircraft taxi gate and the connecting flight departure gate. Further, the points of interest along the optimized path are provided to an associated passenger. Exemplary points of interest include restaurants, restrooms, lounges, ticketing information centers, airport information centers, smoking stations, baggage claim area, business centers, gates at the transit airport and the like. Furthermore, the optimized path is provided based on the points of interest selected by the associated passenger. In addition, the gate path information includes a transport mode, such as walking, a car, a bus, a shuttle and the like to be used by the associated passenger to reach the connecting flight departure gate.

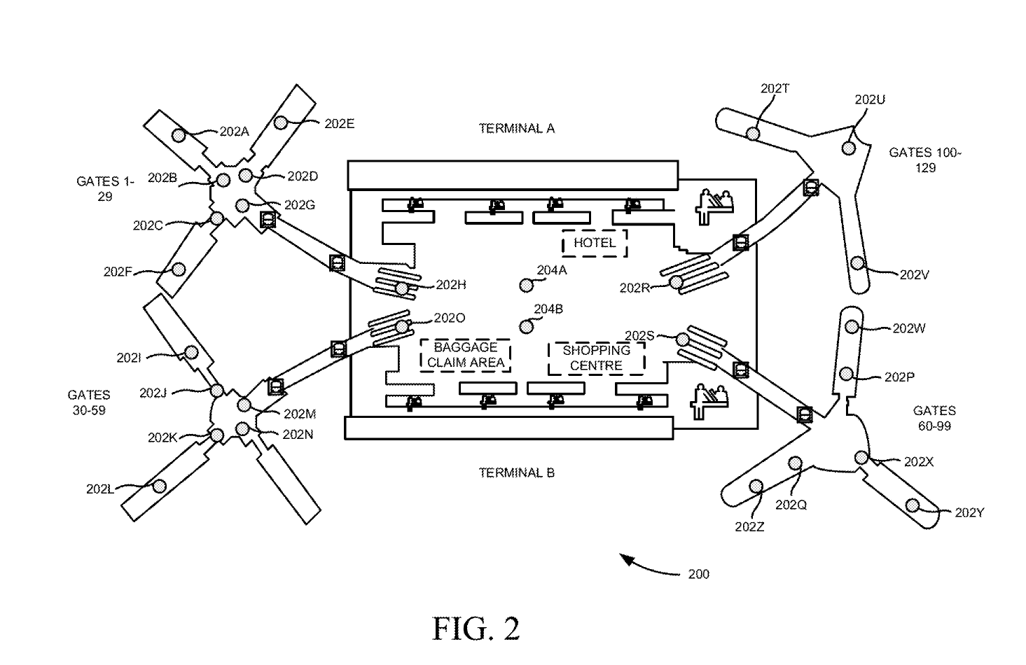

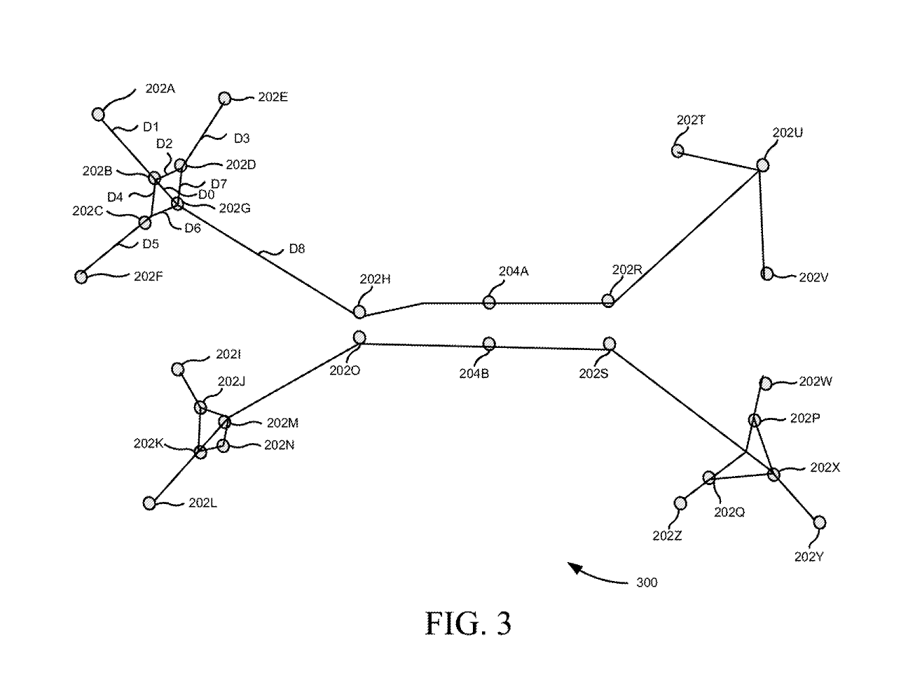

Referring now to FIG. 2, which is a schematic 200 illustrating exemplary points of interest 202A-Z and 204A-B within a transit airport terminal area. For example, the points of interest 202A-Z and 204A-B are imaginary points at various locations in the transit airport terminal area. Exemplary points of interest include restaurants, restrooms, lounges, ticketing information centers, airport information centers, smoking stations, baggage claim area, business centers, gates at the transit airport and the like. In one embodiment, the points of interest 202A-Z and 204A-B are used as reference points for forming a distance matrix (e.g., a distance matrix 400). For forming the distance matrix, distances between the points of interest 202A-Z and 204A-B are computed. This is explained below in more detail with reference to FIG. 3.

Referring now to FIG. 3, which illustrates a distance network 300 between some of the points of interest 202A-H, such as those shown in FIG. 2, according to one embodiment. The distance network 300 includes distance information between the points of interest 202A-H. As shown in FIG. 3, distance between the points of interest 202A and 202B is D1. Further, distance between the points of interest 202B and 202D is D2. Furthermore, distance between the points of interest 202D and 202E is D3. In addition, distance between the points of interest 202B and 2020 is D4. Also, distance between the points of interest 202C and 202F is D5. Further, distance between the points of interest 202C and 202G is D6. Furthermore, distance between the points of interest 202G and 202D is D7. In addition, distance between the points of interest 202G and 202H is D8. Moreover, distance between the points of interest 202B and 202G is D0. For example, the distances between the points of interest 202A-H can be several kilometers based on complexity of the transit airport terminal area.

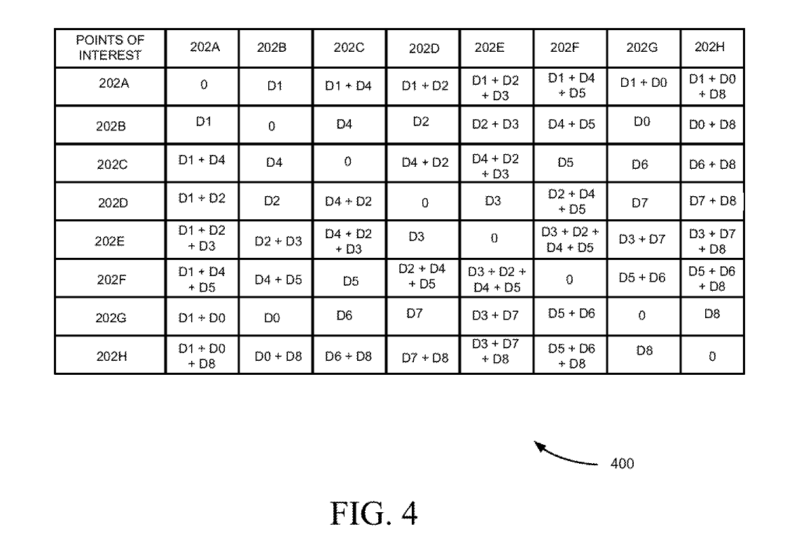

Referring now to FIG. 4, which illustrates an exemplary distance matrix 400 formed by using the distance network 300, such as the one shown in FIG. 3. The distance matrix 400 includes the distance information associated with the points of interest 202A-H, such as those shown in FIG. 3. For example, the distance matrix 400 includes shortest distance information associated with the points of interest 202A-H. In one embodiment, the ground station system includes the distance matrix 400. In this embodiment, the distance matrix 400 includes distance information associated the points of interests, for example, gates at the transit airport. Further, the ground station system automatically provides the optimized aircraft taxi gate selection option to the pilot as an advisory on the display device based on the passenger connecting flight information and the distance information. In another embodiment, the distance matrix 400 includes distance information associated with the points of interest, for example, airline specific gates at the transit airport. In this embodiment, the optimized aircraft taxi gate selection option is automatically provided to the pilot based on the shortest distance from one of the airline specific gates till connecting flight departure gates associated with the connecting flights of one or more passengers on board the aircraft.

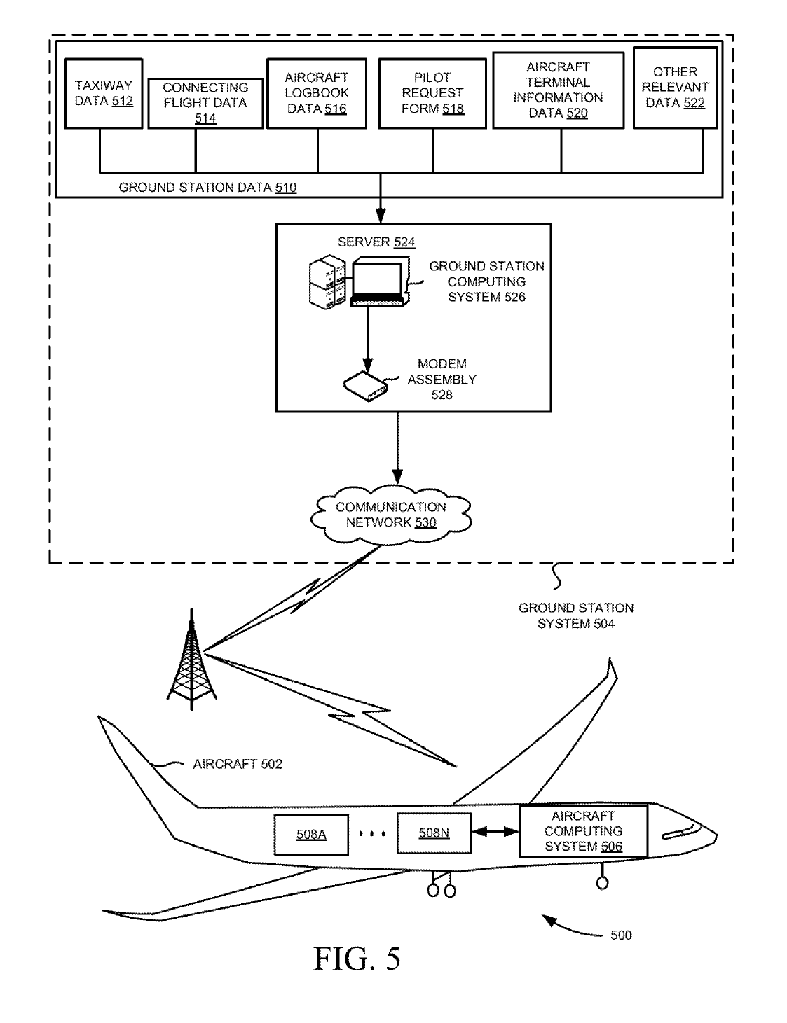

Referring now to FIG. 5, which illustrates a system 500 for providing the gate path information to the passengers on board the aircraft 502 based on the connecting flight information, according to one embodiment. As shown in FIG. 5, the system 500 includes an aircraft 502 and a ground station system 504. For example, the ground station system 504 includes an airport server and the like. Further, the aircraft 502 includes an aircraft computing system 506 and a plurality of passenger entertainment display devices 508A-N. For example, the aircraft computing system 506 includes a flight management system (FMS), an aircraft cockpit system, an aircraft navigation system and the like. Furthermore, the ground station system 504 includes a server 524. In addition, the server 524 includes a ground station computing system 526, a modem assembly 528 and ground station data 510 residing in the ground station computing system 526. In one embodiment, the ground station data 510 includes taxiway data 512, connecting flight data 514, aircraft logbook data 516, a pilot request form 518, aircraft terminal information data 520 and other relevant data 522. In one exemplary implementation, the ground station data 510 is updated as and when the pilot selects an aircraft taxi gate for taxiing the aircraft 502. Moreover, the plurality of passenger entertainment display devices 508A-N is communicatively coupled to the aircraft computing system 506.

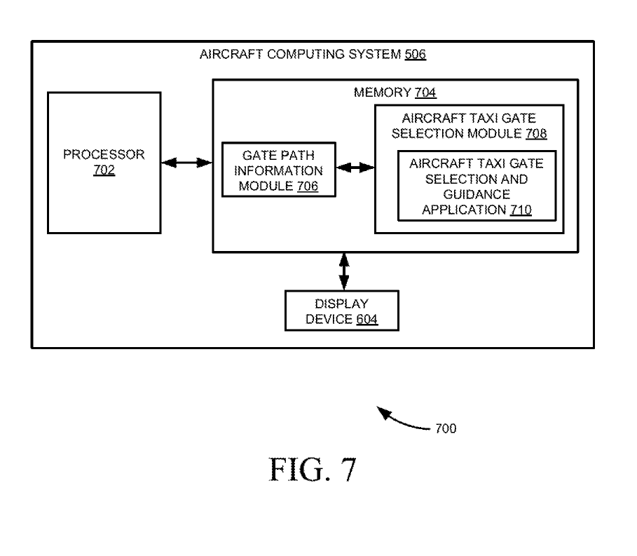

In operation, a communication link is established between the aircraft computing system 506 and the ground station system 504 via a communication network 530 provided by the ground station system 504. The communication network 530 includes WiMax (e.g., 3.5 GHz radio frequency signal). In one embodiment, the communication link is established between the aircraft computing system 506 and the ground station system 504 via the communication network 530 by the aircraft 502 within a range of the communication network 530 at the transit airport. Further, the aircraft computing system 506 has instructions capable of selecting an aircraft taxi gate for taxiing the aircraft 502. Furthermore, the aircraft computing system 506 has instructions capable of providing gate path information to the passengers on board the aircraft 502 upon the aircraft taxi gate selection. This is explained in more detail with reference to FIG. 7.

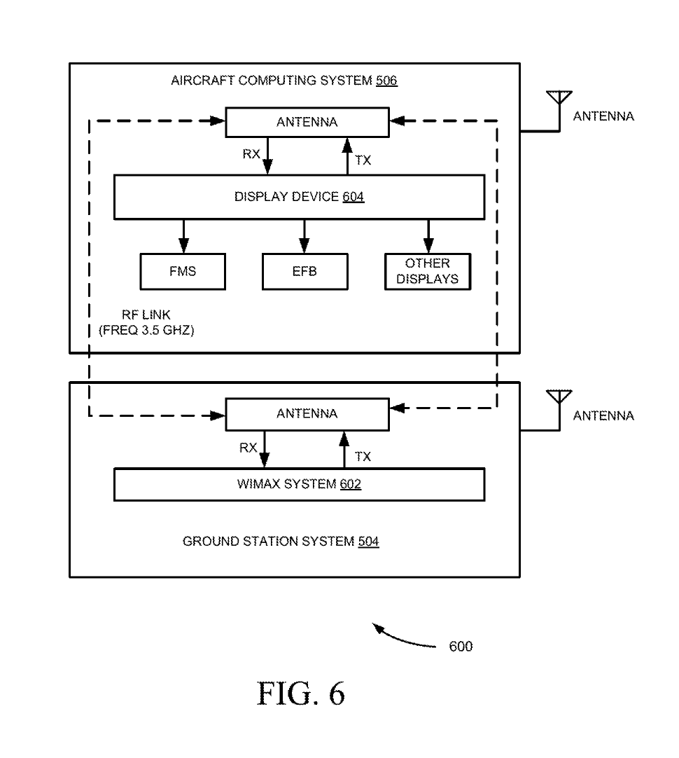

Referring now to FIG. 6, which is a block diagram 600 illustrating major components of the system 500 shown in FIG. 5, according to one embodiment. As shown in FIG. 6, the block diagram 600 includes the ground station system 504 communicatively coupled to the aircraft computing system 506 via a WiMax system 602. Further, the aircraft computing system 506 includes a display device 604 with an integrated modem. For example, the display device 604 is an interactive display. Furthermore, the aircraft computing system 506 displays the aircraft taxi gate selection and guidance application (i.e., an aircraft taxi gate selection and guidance application 710 of FIG. 7) on the display device 604 upon establishing the communication link.

In one embodiment, the aircraft computing system 506 displays a route map on the display device 604 when the aircraft taxi gate is selected for taxiing the aircraft 502. The route map may be also displayed on other non-dedicated displays associated with FMS, EFB, and the like. For example, the route map includes a path between the landing position and the selected aircraft taxi gate. The landing position of the aircraft 502 may be obtained using a global positioning system (GPS). Based on the displayed route map, the pilot taxies and guides the aircraft 502 to the selected aircraft taxi gate. Further, the system 500 may be configured with a feedback mechanism in order to generate warnings to the pilot via messages on the display device 604. This informs the pilot of possible deviation from the track thereby enabling accuracy in the path followed to reach the selected aircraft taxi gate.

Referring now to FIG. 7, which is a block diagram 700 that illustrates major components of the aircraft computing system 506, such as the one shown in FIG. 6, according to one embodiment. As shown in FIG. 7, the aircraft computing system 506 includes a processor 702, memory 704 and the display device 604. Further, the memory 704 includes an aircraft taxi gate selection module 708 and a gate path information module 706. Furthermore, the aircraft taxi gate selection module 708 includes the aircraft taxi gate selection and guidance application 710. In addition, the memory 704 is communicatively coupled to the processor 702. Moreover, the display device 604 is communicatively coupled to the memory 704. Also, the aircraft taxi gate selection module 708 and the gate path information module 706 are communicatively coupled to each other.

In one embodiment, a communication link is established between the aircraft computing system 506 and the ground station system 504, such as the one shown in FIG. 5, via a communication network 530 provided by the ground station system 504. Further, the aircraft taxi gate selection module 708 has instructions capable of allowing the pilot to select the aircraft taxi gate for taxiing the aircraft 502, such as the one shown in FIG. 5, upon establishing the communication link. Furthermore, the gate path information module 706 has instructions capable of notifying the passengers of availability of the gate path information and requesting to input associated connecting flight information on an associated one of the plurality of passenger entertainment display devices 508A-N, such as those shown in FIG. 5, upon the aircraft taxi gate selection. In addition, the gate path information module 706 has instructions capable of allowing one or more of the passengers to input the associated connecting flight information on the associated one of the plurality of passenger entertainment display devices 508A-N upon notification. This is explained in more detail with reference to FIG.

Also, the gate path information module 706 has instructions capable of providing the gate path information to the one or more passengers on the associated one of the passenger entertainment display devices 508A-N based on the input. For example, the gate path information includes an optimized path between the aircraft taxi gate and a connecting flight departure gate in the transit airport, a transport mode to be used by the passenger to reach the connecting flight departure gate and points of interest along the optimized path between the aircraft taxi gate and the connecting flight departure gate to the associated passenger. In one embodiment, the optimized path between the aircraft taxi gate and the connecting flight departure gate is provided based on points of interest selected by the associated passenger. Exemplary transport mode includes a car, a bus, a shuttle and walking. For example, points of interest includes restaurants, restrooms, lounges, ticketing information centers, airport information centers, smoking stations, baggage claim area, business centers, gates at the transit airport and the like.

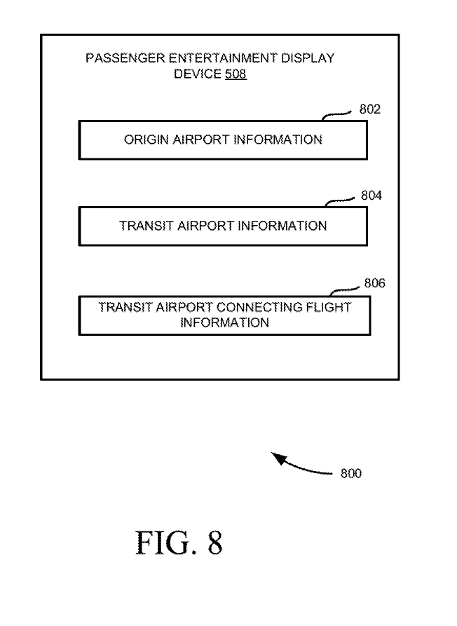

Referring now to FIG. 8, which illustrates selectable icons displayed on the passenger entertainment display device 508, such as the one shown in FIG. 5, according to one embodiment. As shown in FIG. 8, the selectable icons displayed on a passenger entertainment display device 508 upon the selection of the aircraft taxi gate include an origin airport information icon 802, a transit airport information icon 804, and a transit airport connecting flight information icon 806. In one embodiment, the passenger entertainment display device 508 displays information associated with an origin airport upon selecting the origin airport information icon 802. Further, the passenger entertainment display device 508 displays information associated with the transit airport upon selecting the transit airport information icon 804. Furthermore, the passenger entertainment display device 508 displays various options available to the passenger upon selecting the transit airport connecting flight information icon 806 by the passenger. This is explained in more detail with reference to FIG. 9.

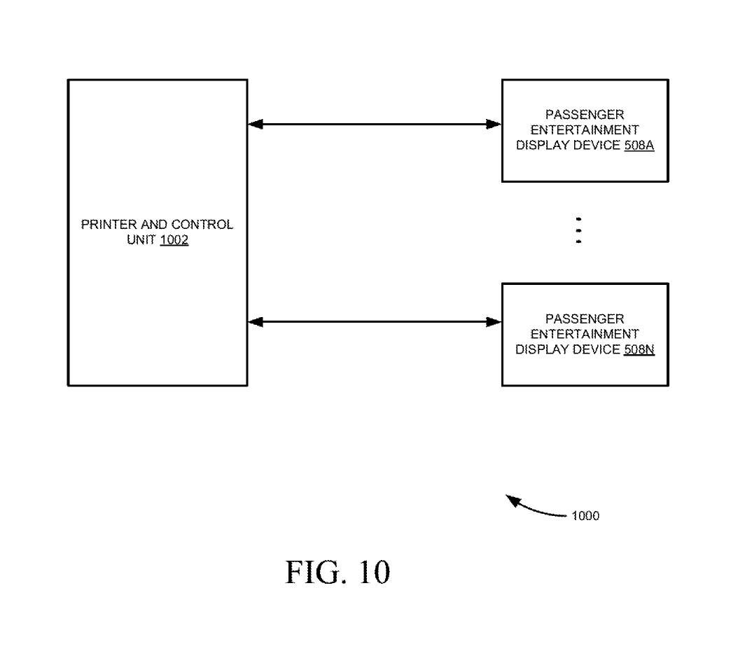

Referring now to FIG. 9, which illustrates various options available to the passenger on the passenger entertainment display device 508 upon selecting the transit airport connecting flight information icon 806, such as the one shown in FIG. 8, according to one embodiment. As shown in FIG. 9, the various options available to the passenger include a select destination option 902, an insert connecting flight number option 904, a show path option 906 and a print path option 908. In one embodiment, the passenger can select the destination using the select destination option 902. Further, the passenger can insert a connecting flight number using the insert connecting flight number option 904. Furthermore, the gate path information is displayed on the passenger entertainment display device 508, to the passenger, upon selecting the show path option 906 upon selecting the destination and inserting the connecting flight number. In addition, the gate path information is printed using a printer and control unit (i.e., a printer and control unit 1002 of FIG. 10) upon selecting the print path option 908. This is explained in more detail with reference to FIG. 10.

Referring now to FIG. 10, which is a schematic 1000 illustrating communication between the passenger entertainment display devices 508A-N, such as those shown in FIG. 5, and the printer and control unit 1002, according to one embodiment. As shown in FIG. 10, the schematic 1000 includes the passenger entertainment display devices 508A-N and the printer and control unit 1002. Further, the passenger entertainment display devices 508A-N are communicatively coupled to the printer and control unit 1002. In one embodiment, the printer and control unit 1002 prints the gate path information upon the selection of the print path option 908, such as the one shown in FIG. 9, by the associated passenger.

In various embodiments, the systems and methods described in FIGS. 1 through 10 provide gate path information to the passengers on board the aircraft upon the aircraft taxi gate selection. The gate path information includes an optimized path between the aircraft taxi gate and the connecting flight departure gate within the transit airport terminal area. Thus, the passengers on board the aircraft can travel to the associated connecting flight departure gates in the transit airport using the optimized path.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method for providing gate path information to passengers on board an aircraft upon an aircraft taxi gate selection, comprising:
establishing a communication link between an aircraft computing system and a ground station system via a communication network provided by the ground station system;
allowing a pilot to select an aircraft taxi gate for taxiing the aircraft upon establishing the communication link;
notifying the passengers on board the aircraft of availability of the gate path information and requesting to input associated connecting flight information upon the aircraft taxi gate selection;
allowing one or more of the passengers on board the aircraft to input the associated connecting flight information upon notification; and
providing the gate path information to the one or more passengers on board the aircraft based on the input.

2. The method of claim 1, wherein the gate path information comprises:
an optimized path between the aircraft taxi gate and a connecting flight departure gate in a transit airport.

3. The method of claim 2, further comprising:
providing points of interest along the optimized path between the aircraft taxi gate and the connecting flight departure gate to an associated passenger.

4. The method of claim 3, wherein the optimized path between the aircraft taxi gate and the connecting flight departure gate is provided based on points of interest selected by the associated passenger.

5. The method of claim 4, wherein the points of interest are selected from the group consisting of restaurants, restrooms, lounges, ticketing information centers, airport information centers, smoking stations, baggage claim area, business centers, and gates at the transit airport.

6. The method of claim 2, further comprising:
a transport mode to be used by an associated passenger to reach the connecting flight departure gate.

7. The method of claim 6, wherein the transport mode is selected from the group consisting of a car, a bus, a shuttle and walking.

8. The method of claim 1, wherein the aircraft computing system is selected from the group consisting of a flight management system (FMS), an aircraft cockpit system, and an aircraft navigation system.

9. The method of claim 1, wherein the one or more passengers on board the aircraft are allowed to input the associated connecting flight information on associated passenger entertainment display devices upon notification.

10. The method of claim 9, wherein the gate path information is provided to the one or more passengers on the associated passenger entertainment display devices based on the input.

11. A system for providing gate path information to passengers on board an aircraft upon an aircraft taxi gate selection, comprising:
a ground station system;
an aircraft computing system residing in the aircraft, wherein the aircraft computing system comprises:
a processor;
memory coupled to the processor, wherein the memory comprises:
a gate path information module; and
an aircraft taxi gate selection module coupled to the gate path information module; and
a display device coupled to the memory;
a plurality of passenger entertainment display devices, residing in the aircraft, coupled to the aircraft computing system; and
a communication network for establishing a communication link between the ground station system and the aircraft computing system, wherein the communication network is provided by the ground station system, wherein the aircraft taxi gate selection module has instructions capable of allowing a pilot to select an aircraft taxi gate for taxiing the aircraft upon establishing the communication link, wherein the gate path information module has instructions capable of notifying the passengers of availability of the gate path information and requesting to input associated connecting flight information on an associated one of the plurality of passenger entertainment display devices upon the aircraft taxi gate selection, wherein the gate path information module has instructions capable of allowing one or more of the passengers to input the associated connecting flight information on the associated passenger entertainment display devices upon notification and wherein the gate path information module has instructions capable of providing the gate path information to the one or more passengers on the associated passenger entertainment display devices based on the input.

12. The system of claim 11, wherein the gate path information comprises:
an optimized path between the aircraft taxi gate and a connecting flight departure gate in a transit airport.

13. The system of claim 12, further comprising:
providing points of interest along the optimized path between the aircraft taxi gate and the connecting flight departure gate to an associated passenger.

14. The system of claim 13, wherein the optimized path between the aircraft taxi gate and the connecting flight departure gate is provided based on points of interest selected by the associated passenger.

15. The system of claim 14, wherein the points of interest are selected from the group consisting of restaurants, restrooms, lounges, ticketing information centers, airport information centers, smoking stations, baggage claim area, business centers, and gates at the transit airport.

16. The system of claim 12, further comprising:
a transport mode to be used by an associated passenger to reach the connecting flight departure gate.

17. The system of claim 16, wherein the transport mode is selected from the group consisting of a car, a bus, a shuttle and walking.

18. The system of claim 11, wherein the aircraft computing system is selected from the group consisting of a flight management system (FMS), an aircraft cockpit system, and an aircraft navigation system.

19. At least one non-transitory computer-readable storage medium for providing gate path information to passengers on board an aircraft upon an aircraft taxi gate selection, having instructions that, when executed by a computing device cause the computing device to:
establish a communication link between an aircraft computing system and a ground station system via a communication network provided by the ground station system;
allow a pilot to select an aircraft taxi gate for taxiing the aircraft upon establishing the communication link;
notify the passengers on board the aircraft of availability of the gate path information and request to input associated connecting flight information upon the aircraft taxi gate selection;
allow one or more of the passengers on board the aircraft to input the associated connecting flight information upon notification; and
provide the gate path information to the one or more passengers on board the aircraft based on the input.

20. The at least one non-transitory computer-readable storage medium of claim 19, wherein the gate path information comprises:
an optimized path between the aircraft taxi gate and a connecting flight departure gate in a transit airport.

21. The at least one non-transitory computer-readable storage medium of claim 20, further comprising:
providing points of interest along the optimized path between the aircraft taxi gate and the connecting flight departure gate to an associated passenger.

22. The at least one non-transitory computer-readable storage medium of claim 21, wherein the optimized path between the aircraft taxi gate and the connecting flight departure gate is provided based on points of interest selected by the associated passenger.

23. The at least one non-transitory computer-readable storage medium of claim 22, wherein the points of interest are selected from the group consisting of restaurants, restrooms, lounges, ticketing information centers, airport information centers, smoking stations, baggage claim area, business centers, and gates at the transit airport.

24. The at least one non-transitory computer-readable storage medium of claim 20, further comprising:
a transport mode to be used by an associated passenger to reach the connecting flight departure gate.

25. The at least one non-transitory computer-readable storage medium of claim 24, wherein the transport mode is selected from the group consisting of a car, a bus, a shuttle and walking.

26. The at least one non-transitory computer-readable storage medium of claim 19, wherein the aircraft computing system is selected from the group consisting of a flight management system (FMS), an aircraft cockpit system, and an aircraft navigation system.

27. The at least one non-transitory computer-readable storage medium of claim 19, wherein the one or more passengers on board the aircraft are allowed to input the associated connecting flight information on associated passenger entertainment display devices upon notification.

28. The at least one non-transitory computer-readable storage medium of claim 27, wherein the gate path information is provided to the one or more passengers on the associated passenger entertainment display devices based on the input.
